(19) United States
(12) Patent Application Publication
(10) Pub. No.: US 2024/0430372 A1
(43) Pub. Date: Dec. 26, 2024

(54) METHODS AND SYSTEMS FOR ALLOWING USERS TO DEFINE ONE OR MORE SCAN PARAMETERS FOR DIFFERENT RECIPIENTS

(71) Applicants: Sudhakar Navamani, Chennai (IN); Umapathy Bomman, Chennai (IN); Bilal Ahmed Ansari, Chennai (IN)

(72) Inventors: Sudhakar Navamani, Chennai (IN); Umapathy Bomman, Chennai (IN); Bilal Ahmed Ansari, Chennai (IN)

(21) Appl. No.: 18/338,398

(22) Filed: Jun. 21, 2023

(51) Int. Cl. H04N 1/00

(52) U.S. Cl. CPC H04N 1/00482; H04N 1/00413

(57) ABSTRACT

The present disclosure discloses methods and systems for allowing a user to add one or more scan requirements/parameters for one or more recipients. The method includes providing a user interface to a user to select a recipient and a scan menu option. The scan menu option can be such as scan to email, email, fax, scan to destination, Internet fax or the like. Based on the selection of the recipient and the scan menu option, a user interface is displayed listing one or more scan parameters and their corresponding default values. Then, an option is provided to the user to define one or more of the displayed scan parameters for the selected recipient, the one or more scan parameters are defined in accordance with the recipient requirements. After defining, the defined one or more scan parameters are stored against the selected recipient for later retrieval, use, and/or for scan activity.

### TECHNICAL FIELD

The present disclosure relates to the field of scanning. More specifically, the disclosure relates to methods and systems for allowing users to define one or more scan parameters for different recipients.

### BACKGROUND

With the large need and increase in digitalization, there exists a vital need for documents to be shared and/or stored in digital format. Printers and scanners play an important part in converting documents from printed version to digital version, whether it is a confidential document, a personal document, or an official document. But there exists a concern of providing manual inputs multiple times and applying attributes/parameters, specifically, at the time of scanning. For example, user/sender spends more time for scan operations based on recipient's desired format. If a user has to send a single document to multiple recipient's, she has to choose a variety of different parameters from a number of options based on the recipient's requirements/expectations and this results in doing the same job repeatedly and loss of time. Sometimes, the user may not apply all desired scan parameters due to huge amount of time and manual efforts involved. Similarly, the user faces challenges while sending multiple documents to the same recipient or different recipients. For example, in both the scenarios, the user requires to scan each and every document individually for each recipient and further requires sending each scanned document individually as a separate activity. This repetition of tasks, and time-consuming steps leads to user's discomfort always.

As of now, there is no solution that solves this time-consuming concern and repetitive & manual efforts involved. In this light, there is a need for methods and systems to solve the above-mentioned concerns.

### SUMMARY

According to aspects illustrated herein, a method for allowing a user to define one or more scan requirements for one or more recipients is disclosed. The method includes providing a user interface to a user to select a recipient and a scan menu option. The scan menu option can be such as scan to email, email, fax, scan to destination, Internet fax or the like. Based on the selection of the recipient and the scan menu option, a user interface is displayed listing one or more scan parameters and their corresponding default values. Then, an option is provided to the user to define one or more of the displayed scan parameters for the selected recipient, the one or more scan parameters are defined in accordance with the recipient requirements. After defining, the defined one or more scan parameters are stored against the selected recipient for later retrieval, use, and/or for scan activity.

According to aspects illustrated herein, a method for scanning is disclosed. The method includes receiving a document for scanning. Then, a selection of a recipient and a scan menu option via a user interface is received. After this, a scan activity for the received document is initiated. It is then checked if there are defined scan parameters for the selected recipient. Based on the check, automatically applying the defined scan parameters for the selected recipient. Finally, a scanned document is output such that the scanned document is in accordance with the recipient requirements.

According to furthermore aspects illustrated herein, a method is disclosed. The method includes providing a user interface to a user to select a recipient and a scan menu. Based on the selection of the recipient and the scan menu, a user interface is displayed listing one or more scan parameters and their corresponding default values. The user is then allowed to define one or more of the displayed scan parameters for the selected recipient. After defining, the defined one or more scan parameters are stored against the recipient for later retrieval and/or use. Then, a document for scanning is received. A selection of a recipient and a scan menu are received, via a user interface. Based on the selection, it is checked if there are defined scan parameters for the selected recipient. Based on the check, the defined scan parameters are automatically applied on scanned data, for the selected recipient, without requiring the user to input the scan parameters at the time of scanning.

Finally, a scanned document is output such that the scanned document is in accordance with the recipient requirements.

According to additional aspects illustrated herein, a multi-function device for allowing a user to add one or more scan requirements for one or more recipients is disclosed. The multi-function device includes a user interface that allows a user to select a recipient and a scan menu option. A controller is for: based on the selection of the recipient and the scan menu option, displaying a list of one or more scan parameters and their corresponding default values via the user interface; allowing the user to define one or more of the displayed scan parameters for the selected recipient, the one or more scan parameters are defined in accordance with the recipient requirements; and after defining, storing the defined one or more scan parameters against the selected recipient for later retrieval, use, and/or for scan activity.

According to additional aspects illustrated herein, a multi-function device for scanning a document is disclosed. The multi-function device includes a receiver for receiving the document for scanning. A controller is for: receiving a selection of a recipient and a scan menu option via a user interface: initiating scan activity for the received document; based on the selection, checking if there are defined scan parameters for the selected recipient; and based on the check, automatically applying the defined scan parameters for the selected recipient; and outputting a scanned document such that the scanned document is in accordance with the recipient requirements.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 shows an exemplary environment in which various embodiments of the present disclosure can be practiced.

FIG. 2 is a block diagram illustrating various components of a multi-function device, in accordance with an embodiment of the present disclosure.

FIGS. 3A-3E are exemplary snapshots according to implementation of the present disclosure.

FIGS. 4A-4C show exemplary scenarios in accordance with existing solutions, whereas FIG. 4D showcases an exemplary scenario implemented in accordance with the present disclosure.

FIG. 5 is an exemplary method flowchart for allowing a user to define scan preferences from recipient perspective.

FIG. 6 is a method flowchart for scanning a document and automatically applying the defined scan preferences for a selected recipient.

FIG. 7 is a complete method flowchart for allowing a user to define scan preferences for a recipient and further applying the defined scan preferences for the recipient at the time of scanning.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “multi-function device” is a single device that performs one or more functions such as, but not limited to, printing, scanning, copying, imaging, or the like. The multi-function device may include software, hardware, firmware, or a combination thereof. In the context of the current disclosure, the multi-function device allows users to define one or more scan preferences from recipient perspective and further applies the defined scan preferences at the time of scanning. The scan preferences can be defined in terms of scan parameters.

The “scan parameters” refer to include any parameters that can determine the outcome of scan activity i.e., scanned document. Few non-limiting examples of scan parameters include scan color, orientation, scan destination, file format, file extensions or the like. More examples are discussed in detail below.

The term “scanned data” refers to raw scanned images/output generated upon scanning, where no image processing techniques are implemented. The scanned data refers to intermediate scanned images. The term “scanned document” refers to an output generated upon completion of the scan activity. The scanned document can be referred to as scanned output. The scanned document is in Mixed Raster Compression (MRC) file format such as PDF. The term “document” refers to a document submitted for scanning and the same is in physical form such as printed on paper. The term “scanned document” and “scanned data” refers to an output generated upon completion of scanning activity and partial completion of the scanning activity, respectively. The scanned document and the scanned data are in the virtual form or digital form.

The “user” can be any user who defines scan parameters for one or more recipients. The user can be an admin user, or any user of an organization who has given rights to define scan parameters and/or is aware of recipient's requirements.

The term “recipient” refers to users who receive the scanned document in the desired format. The recipient can be customers or clients of the user, for example. The scanned document is generated in accordance with their requirements. The term “requirements” include any preferences or choices of the recipient, policies, guidelines, or any pre-defined preferences of an organization in terms of receiving the scanned document.

The term “define” refers to providing input to scan parameters based on recipient's requirements. The input is provided by the user. By default, each scan parameter has a value, or a setting which is defined at the time of configuring the multi-function device. These scan parameters are set at default settings, known as machine default scan settings. The user changes the default scan parameters according to the recipient requirements. Defining can include changing/editing the default values of the one or more scan parameters in accordance with the recipient requirements.

The term “use” refers to include using the defined scan parameters for any purpose while implementing the disclosure. For example, the defined scan parameters can be retrieved while scan activity is in progress. The defined scan parameters can be retrieved for display, modification, confirmation from the user, or the like.

The term “computing device” refers to a device that the user typically uses for his day-to-day work, submitting print commands and other purposes. Examples of the computing device include, but are not limited to, a personal computer, a desktop, a laptop, a mobile phone, a mobile device, a tablet, a Personal Digital Assistant (PDA), a smart-phone or any other device capable of data communication and/or scan submission. In context of the current disclosure, the computing device includes Internet Services such as CentreWare Internet Services (CWIS) that allows users to define scan parameters.

### Overview

The present disclosure provides methods and systems for allowing users to define scan parameters and can later apply at the time of scanning/requirement. The present disclosure proposes a multi-function device and corresponding methods to do the same. For example, the method allows users to define a variety of scan parameters for one or more recipients by adding the recipients in the multi-function device's address book. Later, whenever that recipient is called/selected in any of the scan related menus such as Scan to Email, Fax, Internet Fax or Scan to Destination, the defined scan parameters as stored are automatically applied to a scan job. This way, the scanned document is delivered to the recipient in the desired format. The recipient can be an existing contact in the address book or can be added to the address book at a later point. The recipient may or may not be a part of the organization, but it is authorized to receive scanned documents from the user. This reduces the manual effort of the user and further eliminates the need for the user to apply parameters for every scan job or for every recipient.

### Exemplary Environment

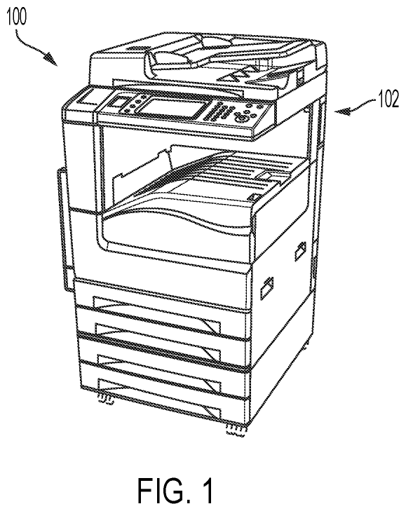

FIG. 1 shows an exemplary environment 100 in which various embodiments of the disclosure can be practiced. The environment 100 includes a multi-function device 102 that provides one or more functionalities such as printing, scanning, imaging, copying, and so on. The multi-function device 102 as shown is just one example but the environment 100 may include a scanner, or any device with scanning functionalities. In context of the present disclosure, the multi-function device 102 allows a user to define one or more scan parameters for one or more recipients and later automatically applies the defined scan parameters for the recipients, at the time of scan activity.

The environment 100 can be an organization where one or more users are present. The one or more users can be employees the organization or otherwise associated with the organization. The users use the multi-function device 102 for various purposes such as scanning, printing, copying, or other imaging functionalities. The users are required to send scanned documents to other users i.e., recipients, on a regular basis such as daily basis, weekly basis, bi-weekly basis, monthly basis or the like. The recipients can be customers, clients of the user or organization. In other examples, the recipients can be manager, CEO, decision maker, VP, or a director of the organization. In further examples, the recipient can be anyone who receives the scanned document from the user on a regular basis.

In implementation, the multi-function device 102 provides a user interface to the user to define scan parameters for recipients. The user accesses the user interface, defines scan parameters which are stored for later retrieval, and/or use. The scan parameters can be defined using another device such as a computing device of the user. The user can access Internet Services such as CentreWare Internet Services (CWIS) to define the scan parameters. CWIS is a user interface of the multi-function device 102 that can be accessed via a web application, and this provides a better view of various options and features included while defining scan parameters.

At the time of scanning a document, the user simply places the document at the multi-function device 102, selects a recipient he wishes to send the scanned document, and the multi-function device 102 then retrieves the defined scanned parameters for the selected recipient and automatically applies the retrieved scan parameters to the document and generates a scanned document such that the scanned document is output in accordance with the recipient requirements. This way, the user does not have to repeat scanning steps or other activities involved in the scanning.

### Exemplary System

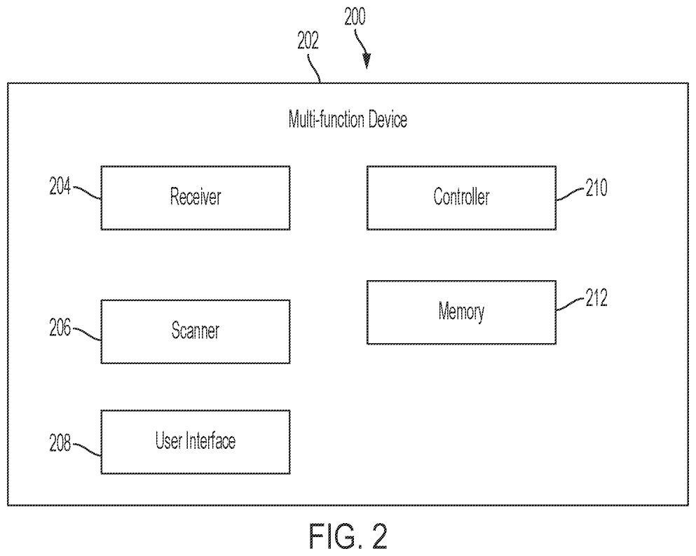

FIG. 2 is a block diagram 200 illustrating various components of a multi-function device 202 for implementing the current disclosure. As shown, the multi-function device 202 includes a receiver 204, a scanner 206, a user interface 208, a controller 210 and a memory 212. The components 202-212 are connected to each other via a conventional bus or a later developed protocol. Further, the components 202-212 communicate with each other for performing various functions of the present disclosure. The multi-function device 202 may further include additional component(s) as required to implement the present disclosure. For example, the multi-function device 202 may include a print engine, a copy engine, or the like.

### Defining Scan Preferences

Initially, a user first defines one or more scan parameters for one or more recipients. To this end, the user accesses the multi-function device 202, specifically, a user interface 208 of the multi-function device 202. The user interface 208 displays multiple options to the user such as print workflow, scan workflow, copy workflow, or the like. The user selects the scan workflow. After selecting the scan workflow, the user interface 208 displays an address book to the user for further steps. The address book includes multiple options such as contacts, email address, scan to email, fax, scan to destination options or the like. The user adds a contact/recipient for which he wishes to define scan parameters. The user provides recipient details such as name, phone, email, or other details of the recipients through the user interface 208. The user further provides/inputs scan menu option details such whether he wishes to add the recipient for scan to email, scan to destination, fax, Internet fax or the like. The scan to email option allows the user to send scanned output via email address. In this case, the user provides an email address of the recipient. The scan to destination option allows the user to send scanned output via a destination such as server location, file server location, cloud location or the like. In this case, the user provides a server address, file server address or a cloud address. The fax option allows the user to send the scanned output via fax. In this case the user provides the fax number of the recipient. The Internet fax allows the user to send scanned output via Internet fax. In this case, the user provides an Internet fax email of the recipient. In context of the current disclosure, the user interface 208 includes an option “apply scan parameters” in the address book. The user selects the option “apply scan parameters”. The selection of the option allows the user to define scan parameters for the selected recipient. After selecting the recipient and the scan menu option, the user interface 208 displays a list of one or more scan parameters and their corresponding default values. The default values are set at the time of configuring the multi-function device 202. The user then defines the scan parameters for the selected recipients. For example, the user can set preferences of the recipient in terms of receiving the scanned document. Defining the scan parameters is a way of setting one or more preferences for the recipient for receiving the scanned documents/output. For example, defining the scan parameters may include setting the file format options, image options, file extensions, orientation, quality, resolution, or the like. The user interface 208 further includes an edit option that allows the user to edit the default settings and define scan parameters according to the choice or requirements of the recipient. The user can edit any scan parameters, all scan parameters, or some of the scan parameters. This way, the user can define all scan parameters for the recipient. Although FIG. 2 is discussed wrt a single recipient, the user can define scan parameters for more than one recipient at a time. For example, if the scan parameters to be defined are same for the multiple recipients, then the user can simply select/add multiple recipients at the time of adding and can define the scan parameters. For example, the user can create a group and add multiple recipients and define scan parameters for them. At the time of scanning, the user can simply select the group and send the scanned document to each recipient of the group.

In scenario 1, the user wants to send scanned document to two different recipients and those recipients may not be added as a part of a group. In such cases, the user defines scan parameters separately for each recipient and then the scanned document is sent to each recipient separately based on the scan parameters defined respectively for each recipient.

In scenario 2, the user wants to send scanned document to multiple recipients and those users can be added as a part of a group. In such cases, after scan completion, a single raw scanned output is created which is further fed to the next level (similar to filter) for image processing techniques. Then, based on the recipient selection, the pre-defined scan parameters are applied, and the scanned document/output is provided.

Once defined by the user, the controller 210 receives all scan parameters as defined by the user. The controller 210 then maps the defined scanned parameters to the selected recipient and stores the mapping of the defined scan parameters in the memory 212 for later retrieval and/or use. For example, the controller 210 automatically applies the defined scan parameters at the time of scanning when that recipient is selected.

### Applying Scan Parameters

This scenario is implemented whenever a user wishes to send a scanned document to a recipient whose scan preferences are defined at the multi-function device 202.

In implementation, the user places a document for scanning at the receiver 204. The document is a printed version. The receiver 204 can be a platen or an automatic document handler. The document can be a single page or a multi-page document and can further include content in the form of text, image, graphics, or a combination thereof. Then, the user accesses the user interface 208 of the multi-function device 202. The user interface 208 displays multiple options to the user such as print workflow, scan workflow, copy workflow, or the like. The user selects the scan workflow. After selecting the scan workflow, the user interface 208 displays an address book to the user for further steps. The user selects one or more recipients from the address book and further selects a scan menu option such as scan to email, fax, Internet, scan to destination or the like. The scan menu option indicates how the document after scanning, to be shared with the recipient such via email, cloud, server or the like. The controller 210 receives the selection of the recipients and the scan menu option. Thereafter, the user initiates scan activity for the received document. For example, the user can press a scan button provided on the multi-function device 202. Or the user can select a scan option given on the multi-function device 202. The controller 210 receives the command from the user for scanning. The controller 210 then triggers the scanner 206 to scan the document. The scanner 206 scans the document and generates scan data corresponding to the document. The scanner 206 then sends the generated scanned data to the controller 210 for further processing such as image processing or generating scanned file. Before generating the scanned document, the controller 210 checks if there are any defined scanned parameters corresponding to the selected recipients. The controller 210 searches for the selected recipient in the memory 212 and identifies if scan parameters are stored against the selected recipient. If the controller 210 finds the defined scanned parameter, the controller 210 retrieves the same from the memory 212 for further processing. The controller 210 displays the scanned parameters to the user for confirmation via the user interface 208. If the user wishes to proceed with the stored scan parameters, the user provides his confirmation through the user interface 208 and the controller 210 proceeds forwards. Otherwise, the user can edit the already defined scan parameters for the selected recipient. In such cases, the user interface 208 is provided with an edit option to edit the defined scan parameters. The user can edit one or any of the scan parameters as required in real-time.

The controller 210 then automatically applies the defined scanned parameters on the scanned data for the selected recipient and finally outputs a scanned document according to the defined scan parameters. For example, the controller 210 creates a raw scanned output and the output is further processed where the user defined scanned parameters are applied to output a final scanned document. This way, the scanned document is output in accordance with the recipient preferences.

### Exemplary Flowcharts

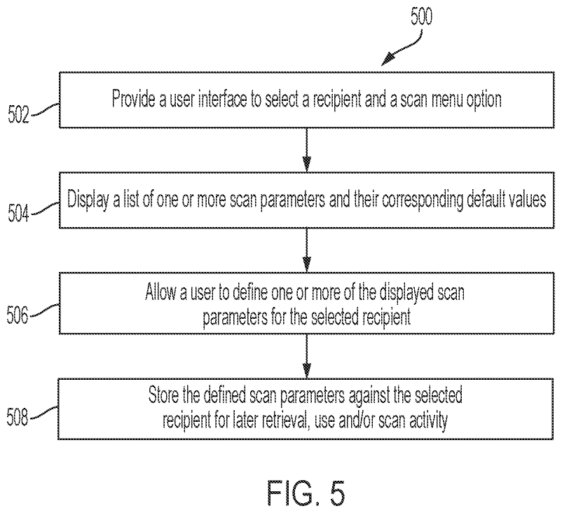

FIG. 5 is a method flowchart 500 for allowing a user to define one or more scan parameters for a recipient, specifically, the scan parameters are defined in accordance with preference/requirement of one or more recipients. The method 500 can be implemented at a device with scanning functionality such as a multi-function device, a scanner, or an equivalent device. For example, the method 500 can be implemented at a multi-function device 102 of FIG. 1 or multi-function device 202 of FIG. 2.

The method 500 begins when a user wishes to share scanned documents with the one or more recipients at a regular time interval such as every day, once in a week, once in a month, or the like. The user accesses the multi-function device, specifically, access a user interface of the multi-function device. The user interface displays one or more workflows such as a print workflow, a scan workflow, a copy workflow, a business workflow or the like. The user selects the scan workflow in context of the current disclosure. Upon selecting the scan workflow, a user interface is provided to the user to select a recipient and a scan menu option, at 502. The user interface displays an address book that stores details associated with all recipients such as name, email address, phone number, etc. These are a few examples, but the address book can include other details relevant for implementing the current disclosure.

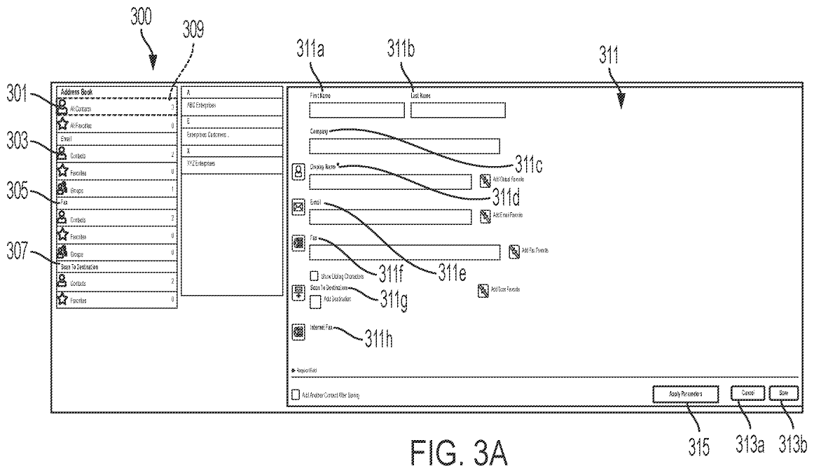

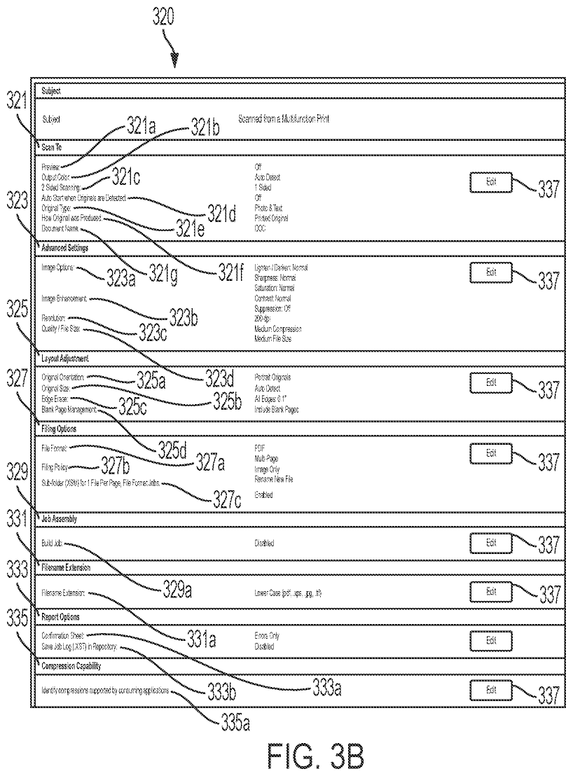

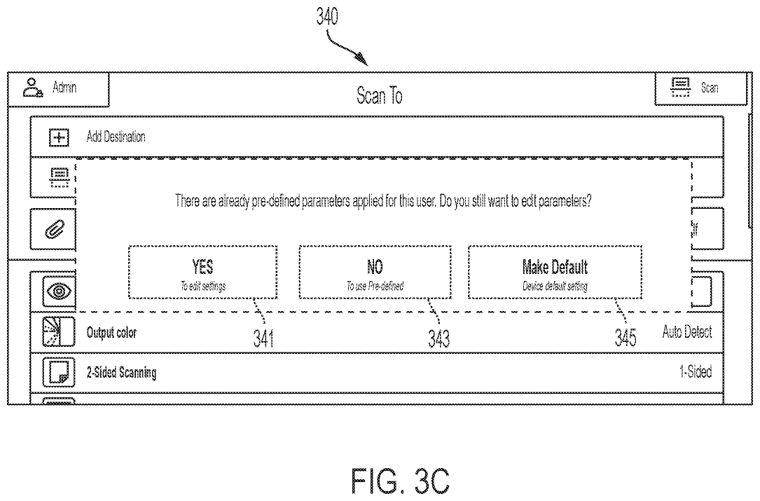

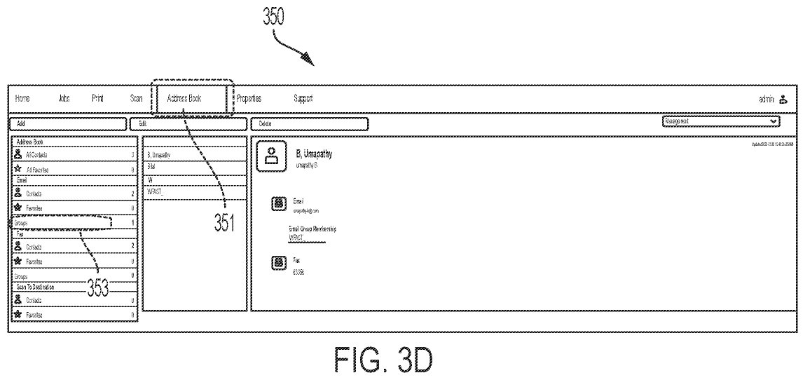

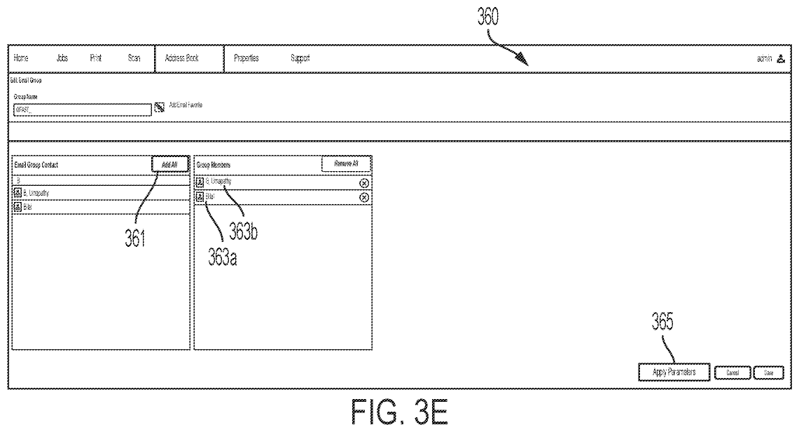

One such example of an address book 300 is shown in FIG. 3A. The address book 300 includes options such as all contacts 301, email 303, fax 305, and scan to destination 307. When the user selects the option contact 301 (the selection is shown with marking 309), then a page menu 311 is presented to the user. The page menu 311 includes various fields such as first name 311a, last name 311b, company name 311c, display name 311d, email 311e, fax 311f, scan to destination 311g, and Internet fax 311h. The first name 311a includes the first name of the recipient, the last name 311b includes last name of the recipient, the company name 311c includes which company the recipient is associated with, the display name 311d indicates the nick name of the recipient or may include first name as the display name, the email 311e includes email address of the recipient, the fax 311f includes fax number of the recipient, the scan to destination 311g includes destination where the scanned document is to be stored such as server location, cloud location, or the like, the Internet fax 311h includes Internet fax number of the recipient. The user can provide required details in the given fields 311. The page menu 311 further includes options such as cancel 313a, save 313b, collectively 313. In context of the current disclosure, the page menu 311 includes “apply parameters” option 315. The apply parameters option 315 allows the user to define scan parameters for the selected recipient such that the selected parameters can be applied at the time of scanning.

Once the recipient and the scan menu options are selected, further a user interface listing one or more scan parameters and their corresponding default values is displayed to the user at 504. Various examples of the scan parameters are shown in the snapshot 320 of FIG. 3B. The scan parameters are defined under headings such as scan to 321, advanced settings 323, layout adjustment 325, filing options 327, job assembly 329, filename extension 331, report options 333, and compression capability 335. As shown, the scan to option 321 includes scan parameters such as preview 321a, output color 321b, 2-sided scanning 321c, auto start when originals are detected 321d, original type 321e, how original was produced 321f, and document name 321g. As shown, the advanced settings option 323 includes scan parameters such as image options 323a, image enhancement 323b, resolution 323c, and quality/file size 323d. As shown, the layout adjustment option 325 includes scan parameters such as original orientation 325a, original size 325b, edge erase 325c, and blank page management 325d. As shown, the filing option 327 includes scan parameters such as file format 327a, filing policy 327b, and sub-folder for 1 file per page 327c. As shown, the job assembly option 329 includes scan parameters such as build job 329a. As shown, the filename extension option 331 includes scan parameters such as file name extension 331a. As shown, the report option 333 includes scan parameters such as confirmation sheet 333a and save job log in repository 333b. As shown, the compression capability 335 includes scan parameters such as identify compression supported by consuming applications 335a. Each of the scan parameters associated with headings/options 321, 323, 325, 327, 329, 331, 333, and 335 may have default value. In context of the current disclosure, the scan parameters can be defined by the user. Each scan option 321, 323, 325, 327, 329, 331, 333, and 335 is provided with an option edit 337, the user can select the edit option 337 and define the scan parameters according to the recipients' need.

At 506, the user is allowed to define one or more of the displayed scan parameters for the selected recipient, the scan parameters are defined in accordance with the recipient requirements. For example, the user can define filename extension 331a to PDF as desired by the recipient. In another example, the user can define/edit the scan parameter resolution 323c to 600 DPI. In further example, the user defines the quality 323d to high compression. Once defined by the user, at 508, the defined scan parameters are stored against the selected recipient for later retrieval, use, and/or for scan activity. The defined scanned parameters are mapped against the selected recipient. At later stages, when the user wants to send the scanned document to this recipient, the user directly selects the recipient, selects the scan option and the multi-function device then automatically applies the defined scan parameters to scanned data and the scanned document is generated and sent to the recipient. This way, the recipient receives the scanned document as per his or her requirement.

The method 500 is discussed for a single recipient but the method 500 can be implemented for multiple recipients. For example, the user can select multiple recipients in the address book and define scan parameters for these multiple recipients. At the time of scanning, the multiple recipients can be selected, and the defined scan parameters can be applied without repeating this activity. This can be done by creating a group and adding multiple recipients in that group.

One such exemplary snapshot 350 is shown FIG. 3D. The snapshot 350 shows a user interface of an address book, marked as 351. The user can select the address book 351, and then select a group option 353 as given in the user interface. The user can then select the add option and add multiple recipients as clearly shown in subsequent figure. As shown in snapshot 360 of FIG. 3E, the user can select the option Add 361 and add multiple recipients such as contact names, email address or the like. Here the user adds 2 recipients marked as 363a and 363b, collectively, by adding their email addresses. The user can select the option Apply parameters 365 to define scan parameters and user interface 320 as discussed above in FIG. 3B is displayed to the user. Once defined, the user can store the defined scan parameters for that group including multiple recipients.

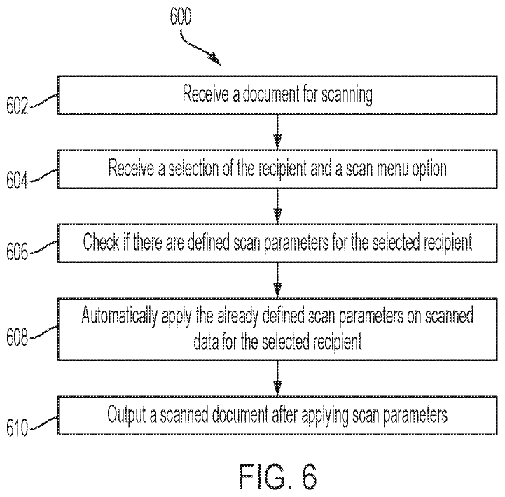

FIG. 6 is a method flowchart 600 for scanning a document, specifically, the method 600 automatically applies scanned parameters defined for a recipient at the time of scanning, without requiring any inputs from a user. The method 600 can be implemented at a device with scanning functionality such as a multi-function device, a scanner, or an equivalent device. For example, the method 600 can be implemented at a multi-function device 102 of FIG. 1 or multi-function device 202 of FIG. 2.

The method 600 begins when a user wishes to send scanned output/document to one or more recipients. The user places a document on a platen for example. At 602, the document for scanning is received from the user. The document is a printed version. The document may include content in the form of text, image, graphics, or a combination thereof. Post that, the user selects a recipient and a scan menu. At 604, the selection of the recipient and the scan menu are received. Thereafter, scan activity for the received document is initiated. For example, the user presses the scan button given on the multi-function device or otherwise on the user interface of the multi-function device. The scanned data corresponding to the received document is generated. The scanned data refers to raw images of the document i.e., without any image processing implementation. Before creating scanned document/applying image processing techniques, at 606, it is checked if there are defined scan parameters for the selected recipient. For example, it is checked whether there are any scanned parameters defined/stored for selected recipient at the multi-function device. If defined, the scanned parameters are retrieved from a memory and displayed to the user for confirmation. If the user is Ok with the defined scan parameters, the method 600 proceeds forward. Otherwise, the method 600 allows the user to edit the defined scanned parameters in real-time. Here, an option is provided to the user to edit the defined scanned parameters.

One such exemplary snapshot 340 is shown in FIG. 3C. The snapshot 340 showcases that the scan parameters are defined for the selected recipient and further checks with the user if he wants to edit the scan parameters. The snapshot 340 appears when the scan parameters are found at the multi-function device. For example, the user is provided with options Yes 341, No 343, and Make Default 345. The user can select any of the options 341, 343 and 345. For example, if the user selects the option Yes 341, then the user is allowed to edit the selected parameters. If the user selects the option No 343, the defined scan parameters are automatically applied to the scanned data. If the user selects the option Make defaults 345, then the default multi-function device's defined parameters can be applied or in some cases, the default user defined parameters can be applied. The user can choose any of the given options to perform their scan jobs easily with no manual efforts.

At 608, based on the check, the defined scan parameters are automatically applied on the scanned data for the selected recipient to generate scanned document. At 610, finally, the scanned document is output after applying the defined scan parameters. The scanned document is then sent to the recipient via email or other modes. This way, the method 600 outputs the scanned document according to the recipient preferences.

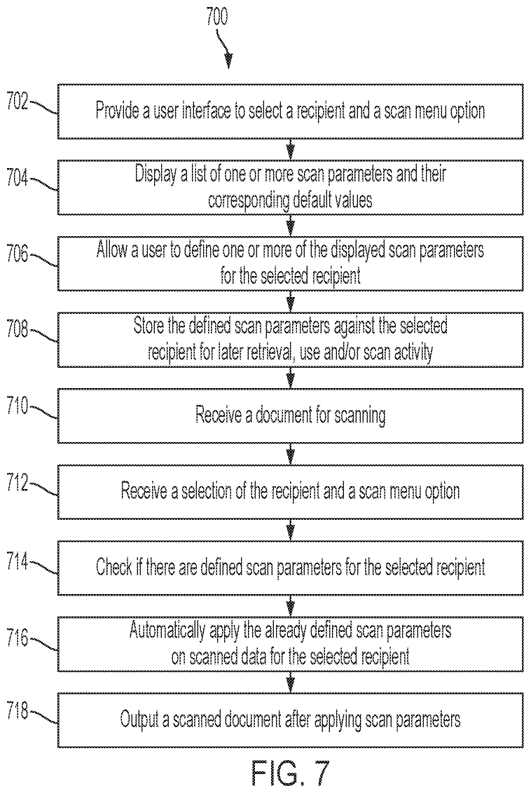

FIG. 7 is a complete method flowchart 700 for defining one or more scan parameters for a recipient and further automatically applying the defined scanned parameters for that recipient at the time of scanning. The method 700 can be implemented at a device with scanning functionality such as a multi-function device, a scanner, or an equivalent device. For example, the method 700 can be implemented at a multi-function device 102 of FIG. 1 or multi-function device 202 of FIG. 2.

At 702, a user interface is provided to a user to select a recipient and a scan menu. Based on the selection of the recipient and scan menu, a user interface listing one or more pre-defined scan parameters and their corresponding default values is displayed at 704. Then, at 706, the user is allowed to define one or more of the displayed scan parameters for the selected user. After defining, the defined scan parameters are stored against the recipient for later retrieval and/or use at 708. At 710, a document for scanning is received. Then, at 712, a selection of a recipient and a scan menu are received. Based on the selection, it is checked if there are defined scan parameters for the selected recipient at 714. Based on the check, the already defined scan parameters are automatically applied on scanned data, for the selected recipient, without requiring the user to define the scan parameters at 716. Finally, at 718, a scanned document is output according to the defined scan parameters.

The method 700 allows the user to edit the defined scan parameter. To this end, an option is provided to the user to edit the defined scanned parameters, before applying to scanned data.

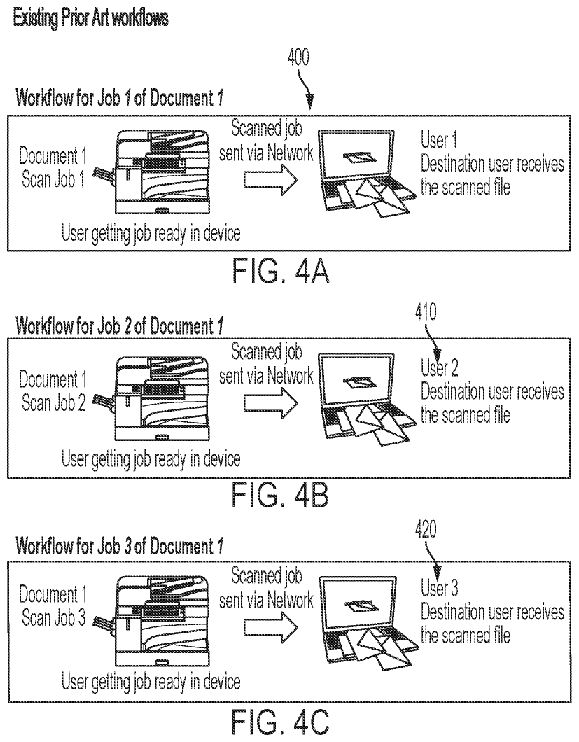

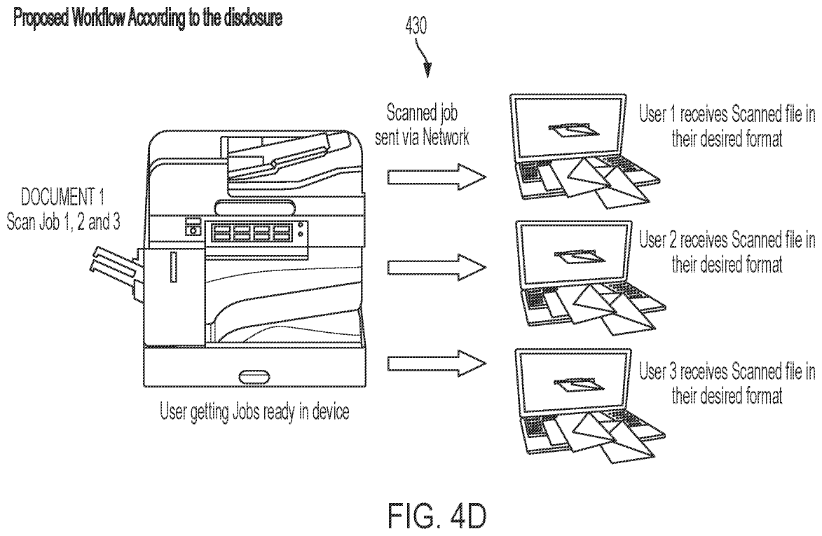

For easy understanding, an exemplary scenario is discussed where a user wishes to send a single scanned document to multiple recipients at the same time. It can be considered that the user wants to send the scanned document to 3 different recipients but in their desired formats. According to the implementation of the existing solutions, the user has to scan job 3 times as shown in snapshot 400, 410, and 420 of FIGS. 4A, 4B and 4C, respectively. For example, according to the existing solution, the user scans the document with the respective desired scan parameters and sends it individually for each recipient as a separate activity. The user further has to send the scanned document to each recipient individually as shown in FIGS. 4A, 4B and 4C. But according to the implementation of the present disclosure as can be in seen in FIG. 4D, marked as 430, the user can simply select 3 recipients at the time of scanning, the defined scan parameters can be applied and the scanned documents are sent to these 3 recipients in a single job processing time and in their desired output format.

This way, the disclosure allows users to complete their scanning activities in one-time activity instead of repeating same activity multiple times. In this case, the user saves ⅓rd of his time even for a single and simple job and this time saving can be massive for more and much time-consuming and complex jobs. This eventually makes the user comfortable and happy.

The disclosure is applicable when a user requires to share scanned output with recipients at regular time intervals such as end of every day, weekly basis, monthly basis and so on. In such scenarios, the user is aware about the recipients' preferences and can easily define scan parameters according to their requirement/preferences.

The present disclosure solves the above-mentioned problems by defining a variety of scan preferences for one or more recipients before scan activity. For example, the disclosure allows the user to define scan preferences of the recipient by adding them in an address book at a scanning device such as a multi-function device. At the time of scan activity, the defined scanned preferences are automatically applied for that recipient with just a single selection/click and scanned output reaches its destination such as via email, via a cloud location, a server location or the like. For example, the methods and systems allow at the time of scanning such that users can send scanned output according to recipients requirements/expectations without repeating the scan steps.

The methods and systems help reduce dependency on a single user as new users can directly retrieve desired scan parameters from the multi-function device. The methods and systems simplify the process for new users as they don't have to get parameter inputs from recipients or other users. The methods and systems allow the user to change the defined scan parameters when the user needs, for example, at the time of scanning or otherwise. The methods and systems facilitate one-time configuration, and this eventually reduces a lot of manual effort and time. The methods and systems further reduce manual configuration errors in scan job. The methods and systems help reduce time that in parallel results in increase of the usage of the multi-function device.

The methods and systems propose a simple and easy approach to handle multiple recipients' desired requirements such as desired scan parameters. The methods and systems allow customized scan preferences to be stored as part of particular recipient in an address book. The methods and systems provide a unique workflow to users to do their scan operation with multiple optional paths to choose their convenient way without much man handle.

The present disclosure allows users to define scan parameters from recipient perspective instead of sender perspective and further allows the users to define these scan parameters for multiple recipients. The methods and systems further can implement multiple scan parameters per scan job. The methods and systems further apply personalized scan parameters uniquely for each recipient. The methods and systems allow the users to select multiple recipients and based on the selection, their personalized defined scan parameters are applied. The methods and systems remove the constraint of having single set of parameters per scan job instead consider scan parameters defined per recipient. The methods and system store customized scan preferences for a particular recipient as a part of address book. The methods and systems provide customer based easy scan methods and systems.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above-described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as receiving, storing, defining, retrieving, scanning, applying, allowing, mapping, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in a transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for allowing a user to add one or more scan requirements for one or more recipients, the method comprising:
providing a user interface to a user to select a recipient from an address book, and a scan menu option;
based on the selection of the recipient and the scan menu option, displaying a user interface listing one or more scan parameters and their corresponding default values;
allowing the user to define one or more of the displayed scan parameters for the selected recipient, the one or more scan parameters are defined in accordance with the recipient requirements; and
after defining, storing the defined one or more scan parameters against the selected recipient for later use.

2. The method of claim 1, further comprising, mapping the defined one or more scan parameters against the selected recipient.

3. The method of claim 1, wherein defining comprises changing the default values of the one or more scan parameters in accordance with the recipient requirements.

4. The method of claim 1, further comprising, automatically applying the defined one or more scan parameters when the recipient is selected at the time of scanning.

5. The method of claim 1, further comprising, allowing the user to input details of the recipient and details of the scan menu option.

6. A method for scanning, comprising:
receiving a document for scanning;
receiving, via a user interface, a selection of a recipient from an address book, and a scan menu option;
initiating a scan activity for the received document;
checking if there are defined scan parameters for the selected recipient;
based on the check, automatically applying the defined scan parameters for the selected recipient; and
outputting a scanned document such that the scanned document is in accordance with the recipient requirements.

7. The method of claim 6, further comprising, displaying the defined scanned parameters to the user for confirmation.

8. The method of claim 6, further comprising, providing an option to the user to edit the defined scanned parameters for the selected recipient.

9. The method of claim 6, further comprising, retrieving the defined scan parameters for further processing.

10. The method of claim 6, wherein the defined scanned parameters are applied to scanned data generated corresponding to the received document.

11. A method, comprising:
providing a user interface to a user to select a recipient from an address book, and a scan menu:
based on the selection of the recipient and the scan menu, displaying a user interface listing one or more scan parameters and their corresponding default values;
allowing the user to define one or more of the displayed scan parameters for the selected recipient;
after defining, storing the defined one or more scan parameters against the recipient for later retrieval and/or use;
receiving a document for scanning;
receiving a selection of a recipient and a scan menu via a user interface:
based on the selection, checking if there are defined scan parameters for the selected recipient;
based on the check, automatically applying the defined scan parameters on scanned data, for the selected recipient, without requiring the user to input the scan parameters at the time of scanning; and
outputting a scanned document such that the scanned document is in accordance with recipient requirements.

12. The method of claim 11, further comprising, providing an option to the user to edit the defined one or more scanned parameters, before applying to the scanned data.

13. The method of claim 11, further comprising, retrieving the defined one or more scan parameters.

14. A multi-function device for allowing a user to add one or more scan requirements for one or more recipients, the multi-function device comprising:
a user interface that allows a user to select a recipient from an address book, and a scan menu option; and
a controller for:
based on the selection of the recipient and the scan menu option, displaying a list of one or more scan parameters and their corresponding default values via the user interface;
allowing the user to define one or more of the displayed scan parameters for the selected recipient, the one or more scan parameters are defined in accordance with the recipient requirements; and
after defining, storing the defined one or more scan parameters against the selected recipient for later use.

15. The multi-function device of claim 14, wherein the controller maps the defined one or more scan parameters against the selected recipient.

16. The multi-function device of claim 14, wherein the controller automatically applies the defined one or more scan parameters when the recipient is selected at the time of scanning.

17. A multi-function device for scanning a document, the multi-function device comprising:
a receiver for receiving the document for scanning; and
a controller for:
receiving via a user interface, a selection of a recipient from an address book and a scan menu option;
initiating a scan activity for the received document;
based on the selection, checking if there are defined scan parameters for the selected recipient;
based on the check, automatically applying the defined scan parameters for the selected recipient; and
outputting a scanned document such that the scanned document is in accordance with recipient requirements.

18. The multi-function device of claim 17, wherein the controller displays the defined scanned parameters to the user for confirmation.

19. The multi-function device of claim 17, wherein the controller provides an option to the user to edit the defined scanned parameters.

20. The multi-function device of claim 17, wherein the controller retrieves the defined scan parameters.
